(19) United States
(12) Patent Application Publication
(10) Pub. No.: US 2013/0162980 A1
(43) Pub. Date: Jun. 27, 2013

(54) APPARATUS FOR NON-INVASIVELY INSPECTING DEFECTS AND METHOD FOR INSPECTING DEFECTS USING THE SAME

(71) Applicants: Jin Hoon KIM, Gyunggi-do (KR); Suk Jin HAM, Seoul (KR)

(72) Inventors: Jin Hoon KIM, Gyunggi-do (KR); Suk Jin HAM, Seoul (KR)

(73) Assignee: SAMSUNG ELECTRO-MECHANICS CO., LTD., Gyunggi-so (KR)

(21) Appl. No.: 13/407,509

(22) Filed: Feb. 28, 2012

(30) Foreign Application Priority Data
Dec. 22, 2011 (KR) 1020110140002

(51) Int. Cl. G01N 21/956; G01J 4/04

(52) U.S. Cl. 356/51; 356/364

(57) ABSTRACT

Disclosed herein are an apparatus for non-invasively inspecting defects, including: a sample irradiation unit having a sample that is an inspection target seated thereon and irradiating polarization to the sample; a light receiving unit detecting polarization from the sample; and a control unit processing and storing each data detected from the light receiving unit, and a method for inspecting defects using the same.

### CROSS REFERENCE TO RELATED APPLICATION

This application claims the benefit of Korean Patent Application No. 10-2011-0140002, filed on Dec. 22, 2011, entitled “Apparatus for Non-invasively Inspecting Defects and Method for Inspecting Defects Using the Same”, which is hereby incorporated by reference in its entirety into this application.

### BACKGROUND OF THE INVENTION

1. Technical Field

The present invention relates to an apparatus for non-invasively inspecting defects and a method for inspecting defects using the same.

2. Description of the Related Art

It is highly likely to deteriorate electrical characteristics of a semiconductor when defects occur on a surface or in an inside of a semiconductor. With the recent development of a semiconductor integrated technology, a circuit configuration having a high-density pattern can be implemented. As a result, a non-invasive precision inspection method is increasingly important so as to prevent performance of products from being deteriorated due to surface defects such as foreign materials, warpage, scratch, or the like, as well as fine defects in the inside of the semiconductor.

As the non-invasive inspection method according to the prior art, a method for inspecting electrical characteristics of a semiconductor has been used, which can detect presence and absence of defects according to presence and absence of the deterioration in electrical performance. However, the method for inspecting electrical characteristics of a semiconductor may not precisely detect defect portions.

### SUMMARY OF THE INVENTION

The present invention has been made in an effort to provide an apparatus for non-invasively inspecting defects having high resolution based on a degree of polarization, ellipticity, or the like, by using polarization so as to inspect defects on a surface or in an inside of a semiconductor and a method for inspecting defects using the same.

According to a preferred embodiment of the present invention, there is provided an apparatus for non-invasively detecting defects, including: a sample irradiation unit having a sample that is an inspection target sample seated thereon and irradiating polarization to the sample; a light receiving unit detecting polarization from the sample; and a control unit processing and storing each data detected from the light receiving unit.

The light receiving unit may include: a lens receiving polarization from the sample; a beam splitter branching incident polarization incident from the lens into four paths; and a plurality of polarization detection units detecting each polarization branched into the four paths from the beam splitter.

The polarization detection unit may include a plurality of linear polarizers detecting different polarization components of the polarization branched and incident, a ¼ wavelength plate, and a CCD imaging device.

At least one of the plurality of polarization detection units may have the ¼ wavelength plate disposed thereon so as to detect a right circular polarization component.

The beam splitter may be a non-polarization beam splitter that does not change polarization property of incident polarization.

The sample irradiation unit may include: a sample seating unit having the sample seated thereon; a light source unit irradiating the polarization to the sample of the sample seating unit; a linear polarizer polarizing a light irradiated to the sample in a linear type or a circular type; a ¼ wavelength plate disposed between the linear polarizer and the sample seating unit; and a collimator forming the polarization polarized in a linear type or a circular type into a parallel ray.

The light source unit may be configured of any one of light sources within an UV-VIS-NIR, FAR-IR, or THz region.

The inspection target may be configured of any one of a semiconductor and a wafer.

According to another preferred embodiment of the present invention, there is provided a method for non-invasively detecting defects, including: (a) transforming light irradiated from a light source into polarization to be irradiated to a semiconductor or a wafer that is the inspection target disposed on a sample seating unit; (b) allowing the polarization detected from the inspection target to pass through a lens disposed in the light receiving unit so as to be input into a beam splitter configuring the light receiving unit; (c) detecting the incident polarization branched into four directions in the inside of the beam splitter by first to fourth polarization detection units configuring the light receiving unit; and (d) performing, by a control unit, storage and image processing on data detected by the first to fourth polarization detection units.

After step (d), the control unit may further include: calculating different linear polarization components I₀, I₄₅, I₉₀, and I_{rc} on the polarization detected from the inspection target so as to calculate a degree of defect polarization and ellipticity of the inspection target using stokes parameter; calculating a degree of polarization, a degree of linear polarization, a degree of circular polarization, and ellipticity by using each of the stokes parameters; and determining presence and absence of the defects of the inspection target by using the calculated degree of polarization, degree of linear polarization, degree of circular polarization, and ellipticity.

### BRIEF DESCRIPTION OF THE DRAWINGS

FIG. 1 is a schematic configuration diagram of an apparatus for non-invasively inspecting defects according to a preferred embodiment of the present invention;

FIG. 2 is a diagram showing a 2-D image series (raw data) having polarization intensity I₀ of component of polarizing angle 0°, polarization intensity I₄₅ of component of polarizing angle 45°, polarization intensity I₉₀ of component of polarizing angle 90°, and polarization intensity I_{rc} of right circular type polarization component that are detected from polarization reflected or transmitted from an inspection target, that is, a semiconductor according to a preferred embodiment of the present invention;

FIG. 3 is a diagram showing a degree of linear polarization (DOLP) of the inspection target, that is, the semiconductor based on stokes parameters obtained by using the polarization intensities according to the preferred embodiment of the present invention;

FIG. 4 is a diagram showing a degree of circular polarization (DOCP) of the inspection target, that is, the semiconductor based on the stokes parameters obtained by using the polarization intensities according to the preferred embodiment of the present invention; and

FIG. 5 is a diagram showing ellipticity of the inspection target, that is, the semiconductor based on the stokes parameters obtained by using the polarization intensities according to the preferred embodiment of the present invention.

### DESCRIPTION OF THE PREFERRED EMBODIMENTS

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

FIG. 1 is a schematic configuration diagram of an apparatus for non-invasively inspecting defects according to a preferred embodiment of the present invention. As shown in FIG. 1, the apparatus for non-invasively inspecting defects is configured to include a sample irradiation unit 100, a light receiving unit 200, and a control unit C.

In more detail, the sample irradiation unit 100 is configured to include a sample seating unit 110 on which the inspection target to be inspected, that is, the semiconductor sample is seated, a light source unit 120, a linear polarizer 130, a 1/4 wavelength plate 140, and a collimator 150.

Further, as the semiconductor sample according to the preferred embodiment of the present invention, a semiconductor wafer has been used.

The light source unit 120 irradiates light to the sample, that is, the wafer as shown. Further, the light source unit 120 may be configured of any one of light sources in an UV-VIS-NIR, FAR-IR, and THz region.

In addition, the linear polarizer 130, which is to polarize light irradiated from the light source unit 120 into linear polarization or circular polarization, is disposed on an upper of the light source unit 120.

Further, the ¼ wavelength plate 140 is disposed between the linear polarizer 130 and the sample seating unit 110 to polarize the light from the light source into a circular type.

Further, the collimator 150, which is to form the polarization polarized into the linear polarization or the circular polarization and incident on the wafer into a parallel ray, is disposed between the linear polarizer 130 and the sample seating unit 110 or between the ¼ wavelength plate 140 and the sample seating unit 110.

As shown in FIG. 1, the light receiving unit 200 is to detect the polarization from the surface or the inside of the semiconductor or the wafer. Meanwhile, the polarization property detected on the wafer has the original property of the incident polarization in the case of a normal state in which there are no defects on the surface or in the inside of the inspection target, that is, the wafer, but the polarization property detected on the wafer is changed in the case in which there are defects on the surface or in the inside of the wafer. In this case, the light receiving unit 200 detects the changed polarization property.

That is, the polarization property incident on the sample is differently changed and new polarization component appears, according to a kind of defects occurring on the surface or in the inside of the inspection target, that is, the semiconductor and the wafer. For example, when linear polarization is incident, circular and oval polarization component appears after the linear polarization is irradiated to the sample.

Further, the light receiving unit 200 is configured to include a lens 210 receiving polarization detected on the surface or in the inside of the sample, in more detail, the inspection target, that is, the wafer, beam splitters 220, and polarization detection units 230a, 230b, 230c, and 230d.

In addition, the beam splitter 220, which is to branch the polarization from the lens 210 into four paths according to the preferred embodiment of the present invention, may be a non-polarization beam splitter that does not change the polarization property of the incident polarization.

Further, the polarization detection units 230a, 230b, 230c, and 230d are to branch the incident polarization into four different paths by using the beam splitter 220 and then, detect four different polarization components from the polarization. According to the embodiment of the present invention, the polarization is branched into four paths, such that the four polarization detection units 230a, 230b, 230c, and 230d may be formed.

The four polarization detection units 230a, 230b, 230c, and 230d are determined as the minimum components for configuring stokes parameters.

In more detail, the polarization detection unit 230a is configured to include a linear polarizer 231, a ¼ wavelength plate, and a CCD imaging device 232 so as to detect the incident polarization branched into each path from the beam splitter.

The linear polarizer 231 is to detect the polarization component determined in the linear polarizer 231 among the polarization components of the incident polarization branched by the beam splitter 220 and incident to the inside of the polarization detection unit 230a.

Further, the CCD imaging device 232 is to detect and image the polarization component determined in the polarization detection units 230a, 230b, 230c, and 230d among the polarization components of the incident polarization passing through the polarization detection units 230a, 230b, 230c, and 230d.

In addition, at least one 230b of the four polarization detection units 230a, 230b, 230c, and 230d further includes the ¼ wavelength plate so as to detect the right circular polarization component of the incident polarization.

In more detail, in the polarization detection unit 230b, a ¼ wavelength plate 233b is disposed between the linear polarization unit 231 and the CCD imaging device 232 so as to detect the right circular polarization component according to the preferred embodiment of the present invention.

Therefore, a phase difference between the linear polarizer 231 and the ¼ wavelength plate 233 configuring the polarization detection unit 230b occurs by 45° clockwise, thereby detecting only the right circular polarization component.

That is, according to the embodiment of the present invention, when the incident polarization detected from the detection target, that is, the wafer transmits through the beam splitter 220, the four polarization detection units 230a, 230b, 230c, and 230d detect the 0°, 45°, 90°, and right circular polarization component of the incident polarization.

In more detail, according to the embodiment of the present invention, the polarization detection unit 230b in which the ¼ wavelength plate 233b is disposed detects the right circular polarization component of the incident polarization and the remaining polarization detection units 230a, 230c, and 230d detect the 0°, 45°, and 90° components of the incident polarization.

Therefore, the defects of the sample such as the silicon wafer patterning the semiconductor configured to have a highly integrated and fine structure can be detected by using the apparatus for non-invasively inspecting defects.

The control unit C is to process and store each data detected from the light receiving unit 200.

More specifically, a software algorithm configuring the control unit C needs to position the CCD imaging device 232 so that each image imaged by the CCD imaging device 232 has the same phase as maximally as possible, during the process of imaging the polarization component of the linear polarization angle 0°, 45°, and 90° and the right circular polarization component of the incident polarization from the polarization detection units 230a, 230b, 230c, and 230d by using the CCD imaging device 232.

Then, image registration that is the image processing method is performed so that the images imaged by the CCD imaging device 232 have the more accurately same image phase.

More specifically, as the image registration method used in the preferred embodiment of the present invention, a linear conformal transform for forming the same image phase transformed by linear movement, rotation, and scaling without changing the imaged image is used.

Therefore, after each image is registered by using the image registration, the polarization intensity I₀ of component of the polarizing angle 0°, the polarization intensity I₄₅ of component of the polarizing angle 45°, the polarization intensity I₉₀ of component of the polarizing angle 90°, and the polarization intensity I_{rc} of right circular type polarization component t are calculated at each of the same pixels of the imaged images.

The above-mentioned four different polarization intensities at each of the obtained pixels are used to obtain the stokes parameters and the definition thereof is as follows.

I=IO+I90, Q=Io+I90, U=I45−I−I−45, V=Irc−Ilc

In addition, the measured polarization intensities IO, I45, I90, and Ire and the polarization intensity I−45 of −45° that is not directly measured and the left circular polarization intensity Ilc may be obtained by the following method.

That is, since I=IO+I90=I45+I−45=Irc+Ilc, I−45=2I45−I, Ilc=2Irc−I.

The degree of linear polarization, the degree of circular polarization, and the ellipticity are obtained by the above-calculated stokes parameters I, Q, U, and V.

Equation of obtaining the degree of polarization (DOP), the degree of linear polarization (DOLP), the degree of circular polarization (DOCP), and the ellipticity that are to be obtained in the preferred embodiment of the present invention is as follows.

$$\begin{matrix}Degree of polorization ( DOP ) = \frac{\sqrt{{Q}^{2} + {U}^{2} + {V}^{2}}}{I} & [ Equation 1 ] \\ Degree of linear polarization ( DOLP ) = \frac{\sqrt{{Q}^{2} + {U}^{2}}}{I} & [ Equation 2 ] \\ Degree of circular polarization ( DOCP ) = \frac{V}{I} & [ Equation 3 ] \\ Ellipticity = \frac{V}{I + \sqrt{{Q}^{2} + {U}^{2}}} = {tan}^{- 1} ( \frac{1}{2} {sin}^{- 1} \frac{V}{I} ) & [ Equation 4 ]\end{matrix}$$

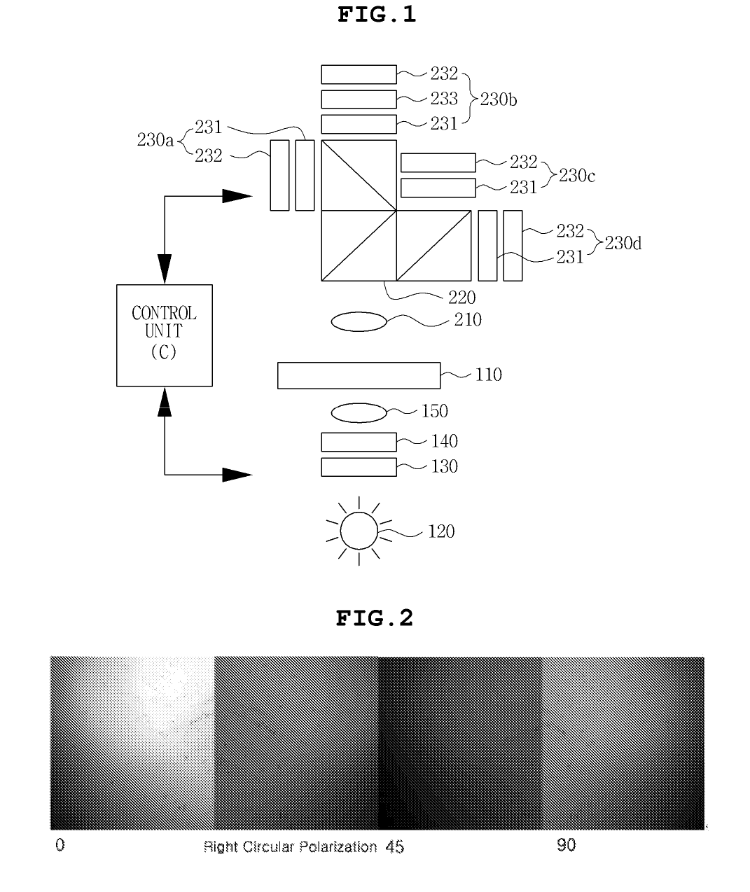

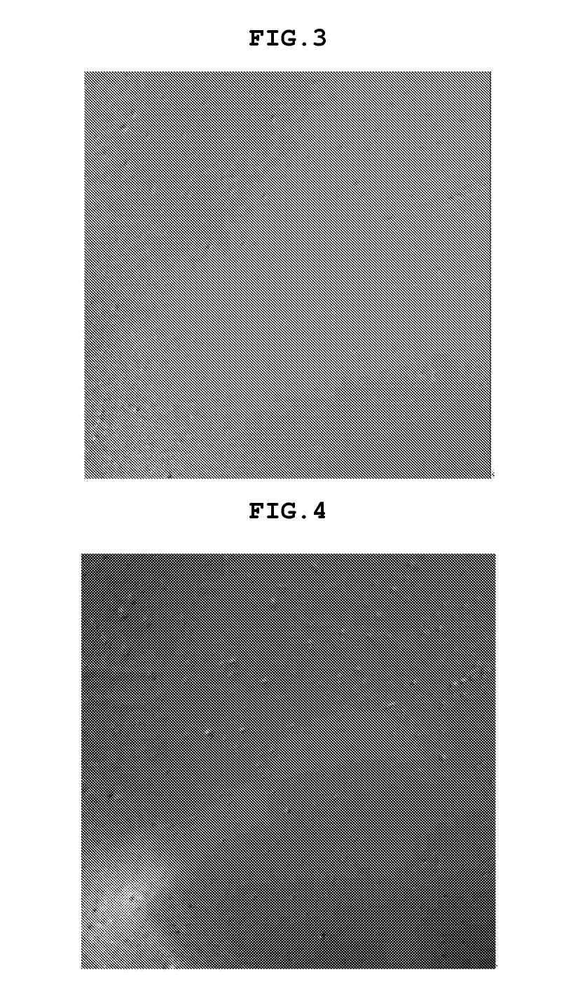

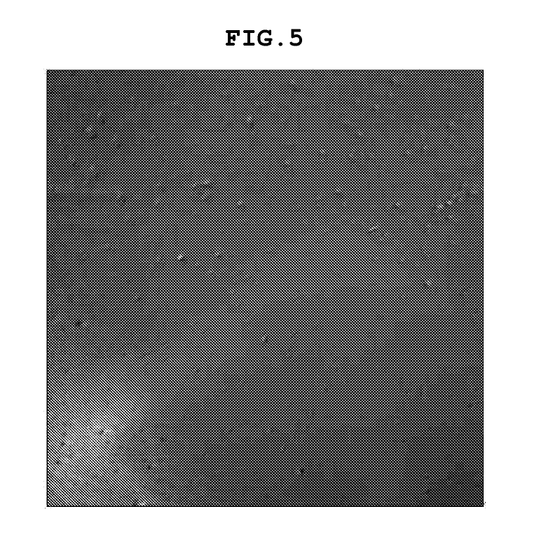

FIG. 2 is a diagram showing a 2-D image series (raw data) having polarization intensity I₀ of component of polarizing angle 0°, polarization intensity I₄₅ of component of polarizing angle 45°, polarization intensity I₉₀ of component of polarizing angle 90°, and polarization intensity I_{rc} of right circular type polarization component that are detected from polarization reflected or transmitted from an inspection target, that is, a semiconductor according to a preferred embodiment of the present invention, FIG. 3 is the degree of linear polarization (DOLP), FIG. 4 is the degree of circular polarization, and FIG. 5 is the ellipticity.

Therefore, the error occurrence and the long time are consumed by separately calculating six different polarization component when obtaining the stokes parameters of the incident polarization so as to obtain the ellipticity, the degree of linear polarization, the degree of circular polarization, and the ellipticity according to the prior art.

However, according to the preferred embodiment of the present invention, the degree of polarization, the degree of linear polarization, the degree of circular polarization, and the ellipticity can be simultaneously obtained without errors.

The method for inspecting semiconductor defects using the apparatus for non-invasively inspecting defects according to the preferred embodiment of the present invention is as follows.

First, light from the light source 120 becomes the linear polarization or the circular polarization by transmitting the polarization unit (the linear polarizer 130 or the linear polarizer 130 and the ¼ wavelength plate 140) and transmits the collimater 150 to form a parallel ray and then irradiates the inspection target, that is, the wafer disposed on the sample seating unit 110.

Thereafter, the polarization detected from the wafer transmits the lens 210 disposed in the light receiving unit and is incident on the beam splitter 220 configuring the light receiving unit 200.

Then, the incident polarization is branched into four directions in the beam splitter 220. Meanwhile, the specific polarization components necessary to obtain the stokes parameters defined in the first to fourth polarization detection units 230a, 230b, 230c, and 230d configuring the light receiving unit 200 among the polarization components of the incident polarization are each detected.

Next, the control unit C performs the storage and image process on the data detected in the first to fourth polarization detection units 230a, 230b, 230c, and 230d and then, the stokes parameters I, Q, U, and V for the incident polarization of the inspection target, that is, the semiconductor are obtained.

Thereafter, the degree of polarization, the degree of linear polarization, the degree of circular polarization, and the ellipticity are obtained, such that the presence and absence of the defects of the wafer is determined.

The preferred embodiments of the present invention can increase the detection sensitivity of the defects on the surface or in the inside of the semiconductor or the wafer.

Further, the preferred embodiments of the present invention can sort various kinds of defects occurring on the surface or in the inside of the semiconductor and the wafer.

Although the preferred embodiments of the present invention have been disclosed for illustrative purposes, they are for specifically explaining the present invention and thus an apparatus for non-invasively inspecting defects and a method for inspecting defects using the same according to the present invention are not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. An apparatus for non-invasively detecting defects, comprising:
a sample irradiation unit having a sample that is an inspection target seated thereon and irradiating polarization to the sample;
a light receiving unit detecting polarization from the sample; and
a control unit processing and storing each data detected from the light receiving unit.

2. The apparatus as set forth in claim 1, wherein the light receiving unit includes:
a lens receiving polarization from the sample;
a beam splitter branching incident polarization incident from the lens into four paths; and
a plurality of polarization detection units detecting each polarization branched into the four paths from the beam splitter.

3. The apparatus as set forth in claim 2, wherein the polarization detection unit includes a plurality of linear polarizers detecting different polarization components of the polarization branched and incident, a ¼ wavelength plate, and a CCD imaging device.

4. The apparatus as set forth in claim 2, wherein at least one of the plurality of polarization detection units has the ¼ wavelength plate disposed thereon so as to detect a right circular polarization component.

5. The apparatus as set forth in claim 1, wherein the beam splitter is a non-polarization beam splitter that does not change polarization property of incident polarization.

6. The apparatus as set forth in claim 1, wherein the sample irradiation unit includes:
a sample seating unit having the sample seated thereon;
a light source unit irradiating the polarization to the sample of the sample seating unit;
a linear polarizer polarizing a light irradiated to the sample in a linear type or a circular type;
a ¼ wavelength plate disposed between the linear polarizer and the sample seating unit; and
a collimator forming the polarization polarized in a linear type or a circular type into a parallel ray.

7. The apparatus as set forth in claim 6, wherein the light source unit is configured of any one of light sources within an UV-VIS-NIR, FAR-IR, or THz region.

8. The apparatus as set forth in claim 1, wherein the inspection target is configured of any one of a semiconductor and a wafer.

9. A method for non-invasively detecting defects, comprising:
(a) transforming light irradiated from a light source into polarization to be irradiated to a semiconductor or a wafer that is the inspection target disposed on a sample seating unit;
(b) allowing the polarization detected from the inspection target to pass through a lens disposed in the light receiving unit so as to be input into a beam splitter configuring the light receiving unit;
(c) detecting the incident polarization branched into four directions in the inside of the beam splitter by first to fourth polarization detection units configuring the light receiving unit; and
(d) performing, by a control unit, storage and image processing on data detected by the first to fourth polarization detection units.

10. The method of claim 9, wherein after step (d), the control unit further includes:
calculating different linear polarization components I₀, I₄₅, I₉₀, and I_{rc} on the polarization detected from the inspection target so as to calculate a degree of defect polarization and ellipticity of the inspection target using stokes parameter;
calculating a degree of polarization, a degree of linear polarization, a degree of circular polarization, and ellipticity by using each of the stokes parameters; and
determining presence and absence of the defects of the inspection target by using the calculated degree of polarization, degree of linear polarization, degree of circular polarization, and ellipticity.
